(19) United States
(12) Patent Application Publication
(10) Pub. No.: US 2003/0026199 A1
(43) Pub. Date: Feb. 6, 2003

(54) Code-division, minimum-shift-keying optical multiplexing

(76) Inventor: Michael H. Myers, Poway, CA (US)

Correspondence Address: ALL OPTICAL NETWORKS, INC., 9440 CARROLL PARK DRIVE, SAN DIEGO, CA, 92121, US

(21) Appl. No.: 09/922,095

(22) Filed: Aug. 3, 2001

(51) Int. Cl. H04J 11/00

(52) U.S. Cl. 370/208; 370/335; 370/342

(57) ABSTRACT

Optical code-division multiplexing and demultiplexing (CDM) using orthogonal codes with minimum shift keying (MSK) waveforms allows more efficient use of the spectrum and greatly reduces cross-channel interference. Receiving multiple baseband data channels, a derivation mechanism converts the data signals into series of impulses. These impulses may be split into odd and even channels, each at half the original data rate, and transmitted to a plurality of Walsh filters configured to have an impulse response corresponding to one of a plurality of orthogonal MSK waveforms. Odd and even channels, encoded with MSK waveforms, may combine into an in-phase and quadrature channel, 90° out of phase. A laser output may be divided, phase shifted, and modulated with the in-phase and quadrature channels, which divisions are then combined into a single multiplexed output. Walsh filters may decode the incoming signal in order to reproduce the original baseband channels.

### BACKGROUND

1. The Field of the Invention

This invention relates to communications encoding, such as is used in computer and telecommunications networks and, more particularly, to novel systems and methods for optical code-division multiplexing

2. Background

Multiplexing is a method for transmitting multiple, distinct signals over a single physical carrier medium. Much of the protocol of computer hardware deals with the encoding and decoding of signals according to some time scheme for maintaining signal integrity and uniqueness from other signals. In conventional time-division types of multiplexing, signals are transmitted within specific time divisions or bit positions. In order to prevent individual bits from being transmitted at the same time, each is encoded into a signal and transmitted over the carrier medium at a specific time.

As transmission rates increase, the individual time divisions available for each small quantity of information in a signal is reduced. However, with the advent of photonic processing, the transmission, encoding, and decoding of photonic signals taken from the electromagnetic spectrum, deserve further consideration. In conventional computer systems, as well as conventional telecommunications networks, the switching, routing, and transmission of signals throughout networks and between processors or processes are major limiting factors in performance. Typically, transmissions of a signal require encoding of the signal in a carrier medium, according to a protocol or format.

Thereafter, transmission occurs as a physical phenomenon in which light, or other electromagnetic radiation, electrical signals, mechanical transmissions, or the like are transferred between a source and a destination. At the destination, a decoder must then manipulate the physical response to the incoming signals, thus reconstructing original data encoded by the sender. Communications in general may include communications between individual machines. Machines may be network-aware, hardware of any variety, individual computers, individual components within computers, and the like.

Thus, the issue of sending and receiving information or message traffic is of major consequence in virtually all aspects of industrial and commercial equipment and devices in the information age. Whether communications involve sending and receiving information between machines, or telecommunications of data signals, audio signals, voice, or the like over conventional telecommunications networks, the sending and receiving requirements of rapidly encoding and decoding are present.

With the advent of photonic signals and photonic signal processing, new speed limits are being approached by transmission media. Moreover, origination of signals can now be executed literally at light speeds. Accordingly, what is needed is a system for multiplexing photonic signals over photonic carrier media in such a way as to maximize throughput speed (bandwidth) and transmission speed, while maintaining the integrity of information.

Traditionally, there are three ways for multiple data streams to share the same channel: time-division multiplexing (TDM), frequency division multiplexing (FDM), or code-division multiplexing (CDM).

At the present time frequency (wavelength) division multiplexing and time-division multiplexing are the primary ways that signals are separated in the electromagnetic spectrum. Generally, it may be considered that both of these methods make use of very primitive codes. Both are easy to tap into or receive, but are also inherently inefficient.

In optical code-division multiplexing, the multiplexing code is the temporally incoherent optical field itself. By using code-division multiplexing (CDM) the spectrum may be used more efficiently and message security is also greatly improved. In a broad bandwidth network CDM also greatly reduces the need for switching. All users transmit at the same time across the entire bandwidth and each uses a different code generator. Each user can receive any of the signals but only the signal “addressed” to the user can be transformed into usable information. Unfortunately, such statistical codes have stronger cross-correlations than one would desire, leading to significant interference between the data streams.

What is needed is an optical code-division multiplexing technique wherein cross-channel interference is greatly reduced and the transmitted channels may be recovered at the receiver with an error rate due solely to laser power and detector sensitivity.

It would also be an advance in the art to provide an efficient way of using optical CDM in order to allow multiple subchannels to be sent on a single carrier frequency.

It would be a further advance in the art to provide a method wherein the baseband data may be encoded with orthogonal codes through a passive filter, thereby permitting use with higher speed photonic signals.

It would be a further advance in the art to provide a modulation method used in conjunction with the orthogonal coding that would provide a constant envelope, thereby greatly reducing distortion and self-interference when passed through nonlinear elements.

### BRIEF SUMMARY AND OBJECTS OF THE INVENTION

In view of the foregoing, it is a primary object of the present invention to provide a method and apparatus for code-division multiplexing and demultiplexing that permits signals to be added together, transmitted, and recovered, while eliminating interference between the transmitted channels.

It is another object to provide an apparatus and method for passively encoding the various channels input to a multiplexer functioning efficiently with higher speed photonic signals.

It is another object to provide an apparatus and method for modulating the individual channels with orthogonal codes in a manner that provides a constant envelope to reduce distortion and self-interference when transmitted through nonlinear elements.

Consistent with the foregoing objects, and in accordance with the invention as embodied and broadly described herein, an apparatus and method are disclosed, in suitable detail to enable one of ordinary skill in the art to make and use the invention. In certain embodiments an apparatus and method in accordance with the present invention may include a plurality of separate synchronous baseband channels, each having data bits that begin and end at the same time. The baseband data may be ones or zeros, ones and negative ones, or other signals originating from a signal generator of some kind, such as an OC3 or OC192 signal, for example.

In the preferred embodiment of the present invention, the separate channels may be received by a plurality of derivation mechanisms configured to convert the baseband data signals into trains of impulses, corresponding to changes in the data from high to low. This arrangement may be used because the impulses may then be passed through a plurality of filters, each having an impulse response corresponding to one of a family of MSK orthogonal codes.

A plurality of commutators may be operably connected to receive the series of impulses and divide them into two separate sub-channels comprising even and odd bits, respectively, each at half the original data rate. This method may be a way to reduce the data rate of the individual channels in the case that slower electronic components are used with the present invention.

Subsequently, MSK Walsh filters having an impulse response comprising an MSK waveform, may be configured to receive the impulses of the even and odd sub-channels, therefore providing sub-channels encoded with the MSK waveforms. Likewise, the other channels may also be encoded with MSK waveforms, each being orthogonal to the others. In certain embodiments, the MSK Walsh filters may be waveguide structures. In the present invention, the MSK Walsh filters are used to encode the separate channels passively, therefore enabling the present invention to be used with higher speed photonic signals. Moreover, one further reason for making the MSK Walsh filters passive devices is that, because each data bit is encoded with an MSK Walsh code, the total bandwidth and the effective bit-rate are increased.

Using Walsh codes modulated with MSK waveforms offers several advantages. The encoding of each channel with an orthogonal code, such as a Walsh code, through a filter allows for the data to be recovered through a corresponding filter in the receiver. Also, modulating the codes with MSK waveforms provides a signal with a constant envelope, thereby reducing distortion and interference caused by transmission through nonlinear elements.

Eventually, all of the MSK-encoded even channels may be combined into a single consolidated output. All of the MSK-encoded odd-channels may be combined into another consolidated output.

A coherent laser source may be provided and a pair of modulators may modulate the consolidated output comprising the even sub-channels into an in-phase signal, whereas the consolidated output comprising the odd sub-channels may be modulated into a quadrature signal, 90° out of phase from the in-phase signal. The in-phase and quadrature channels may subsequently be combined into a single multiplexed output for transmitting across a carrier medium. The use of quadrature amplitude modulation with the present invention provides an output with a constant envelope.

On the receiving end, a splitter may receive the multiplexed output from the carrier medium and split the output into a number of daughter signals, corresponding to the number of channels multiplexed at the transmitter. Each of these daughter signals may be subsequently split into a pair of granddaughter signals, with a 90° phase shift imposed on one of them with respect to the other.

The granddaughter signals may be received by MSK Walsh decoders identical to the filters of the transmitter, wherein a data value is only received for baseband signal encoded with the corresponding MSK waveform. Each decoder receives the waveforms from all of the channels, but will only have an output for the corresponding MSK waveform encoded in the transmitter. All other MSK waveforms will provide a zero, since they are orthogonal to the desired MSK waveform.

The data values may be sent to a plurality of integrating mechanisms, which integrate over a time corresponding to the length of one MSK waveform, and output the corresponding even and odd baseband data signals for each channel of the transmitter. In certain embodiments, the odd and even subchannels may be left as two separate channels or may be combined to reproduce the original baseband data signals at the transmitter.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic block diagram of an optical code-division multiplexer using minimum shift keying waveforms.

FIG. 2 is a schematic block diagram of various waveforms and coding used in the multiplexer and demultiplexer of FIGS. 1 and 3.

FIG. 3 is a schematic block diagram of a demultiplexer used in accordance with the invention.

### DETAILED DESCRIPTION OF THE PREFERRED EMBODIMENTS

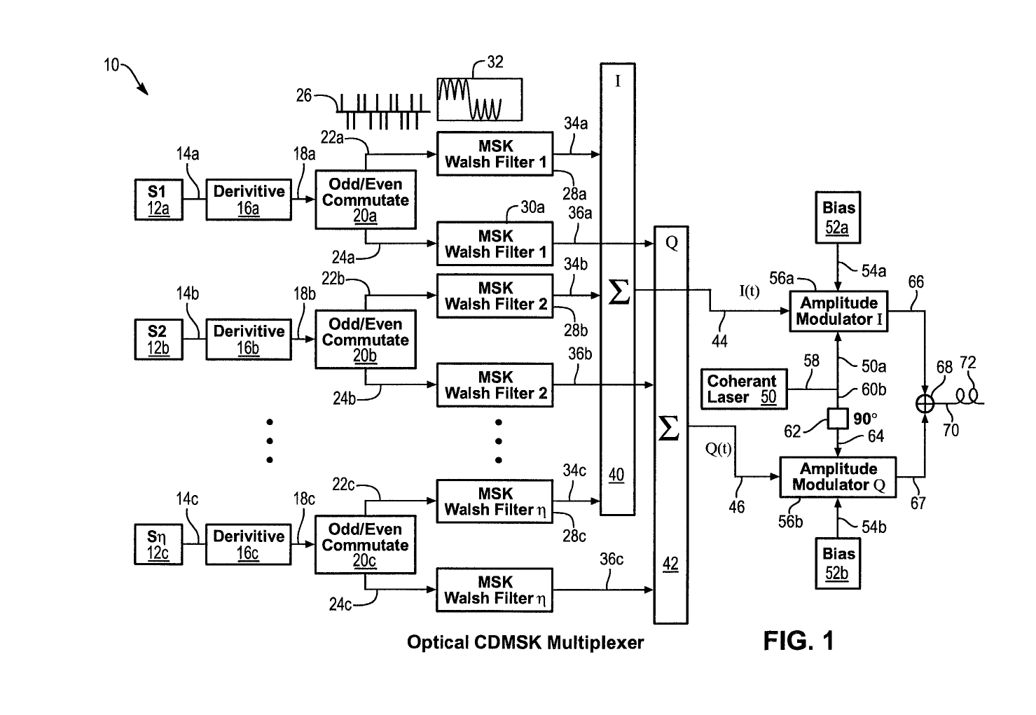

It will be readily understood that the components of the present invention, as generally described and illustrated in the Figures herein, may be arranged and designed in a wide variety of different configurations. Thus, the following more detailed description of the embodiments of the system and method of the present invention, as represented in FIGS. 1 through 3, is not intended to limit the scope of the invention. The scope of the invention is as broad as claimed herein. The illustrations are merely representative of certain, presently preferred embodiments of the invention. Those presently preferred embodiments of the invention will be best understood by reference to the drawings, wherein like parts are designated by like numerals throughout.

Those of ordinary skill in the art will, of course, appreciate that various modifications to the details of the Figures may easily be made without departing from the essential characteristics of the invention. Thus, the following description of the Figures is intended only by way of example, and simply illustrates certain presently preferred embodiments consistent with the invention as claimed.

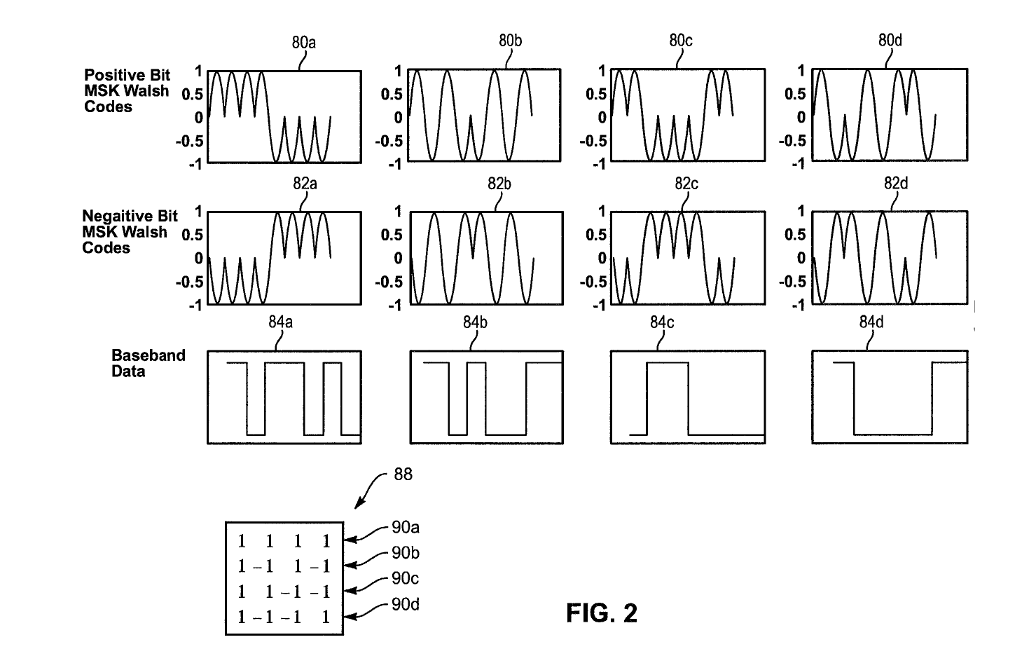

Referring to FIG. 1, while referring generally to FIG. 2, an optical multiplexer 10 using code-division minimum shift keying may be configured to receive a plurality of baseband data signals 12a-c. The baseband data signals 12a-c may represent digital data signals devoid of a carrier frequency, such as is represented by signals 84a-d or waveforms 84a-d of FIG. 2. The baseband data signals may be comprised of ones and zeros or ones and negative ones, for example, such as might be supplied by a signal generator outputting OC3 or OC192.

A plurality of derivation devices 16a-c may be configured to receive the baseband data signals 12a-c from lines 14a-c, taking the derivative of transitions in the data from one digital signal to the next, producing a train of impulses, such as the signal 26. Positive impulses would be representative of a transition from low to high of the signal 12, whereas a negative impulse would be representative of a transition from high to low of the signal 12. The advantage of converting the data pulses to impulses is that the resulting impulses may be passed through a device having an impulse response corresponding to a desired code, such as a Walsh code.

In other embodiments, the present invention may not convert the baseband data 12 into impulses, but may actually convert the high and low data signals of signal 12 directly from baseband data 12 into a coded signal by way of a filter or other encoding device.

A plurality of commutators may be operably connected to receive the impulses through lines 18a-c, and divide the signal 18a-c into two signals 22a-c, 24a-c, each at half the data rate. All even bits may go one direction 22a-c, while all odd bits may go another direction 24a-c. One advantage of this may be that the two bit streams, now at half the original data rate, may make use of slower electronic devices, if needed. Another advantage of this method may be that by dividing the signal 18a-c into a pair of signals 22a-c, 24a-c, the signal 22a-c may be used as an in-phase component and the signal 24a-c may be used as a quadrature component, 90 degrees out of phase from the in-phase component. This method may allow for the use of certain types of modulation techniques, such as quadrature amplitude modulation, which may provide an output envelope that is less easily distorted.

A filter 28a, having an impulse response such as waveform 32, may be configured to receive the impulses from the line 22a, producing the waveform 32 for each positive impulse, or the negative of the waveform 32 for each negative impulse. The result may be a train of successive waveforms (either negative or positive).

The filters 28a, 30a may encode the signals 22a, 22b with the same waveform 32, while the filter pair 28b, 30b, and the pair 28c, 30c may encode the signals 22b, 24b and the signals 22c, 24c, respectively, with waveforms orthogonal to the waveform 32. This topic will be discussed in more depth in the description for FIG. 2.

The signals 22a-c, 24a-c may be encoded by the filters 28a-c, 30a-c, in part, because the filters 28a-c, 30a-c may be implemented to function passively, which may allow the filters 28, 30 to keep pace with higher speed photonic. In reality, the signals 22a-c, 24a-c may be modulated electronically with orthogonal codes at the inputs 14a-c. However, modulating the signals electronically may be too slow to work in higher speed photonic systems. Moreover, one further reason for making the filters passive devices may be that, because each data bit is encoded with an MSK Walsh code, the bit-rate may be effectively increased and thus the total effective informational bandwidth may also increase. Thus, it may be difficult to provide non-passive electronic components that are able to keep pace with this higher effective bit-rate.

The even signals 34a-c, each encoded with a different orthogonal code, may then be combined in a combiner 40 to form a consolidated signal 44. Likewise, the odd signals 36a-c, each encoded with a different orthogonal code (equivalent to their even counterpart) may then be combined in another combiner 42 to form a second consolidated signal 46. The consolidated signals 44, 46 may be thought of as an in-phase 44 and a quadrature signal 46.

A coherent laser source 50 may be provided, in accordance with the invention, to produce a coherent laser 58 on line 58, which may be split into a pair of daughter signals 60a, 60b. A phase shifter 62 may also be provided to shift the daughter signal 60b by 90° to produce a phase-shifted signal 64. Subsequently, a pair of amplitude modulators 56a, 56b may be configured to modulate the laser signals 60a, 64 with the consolidated signals 44, 46, respectively, producing an in-phase signal 66 and a quadrature signal 67, 90° out of phase with the in-phase signal 66.

In other embodiments, the modulators 56a, 56b may use other modulation techniques, such as amplitude, phase, frequency, and spatial modulation. Generally, the object of the modulators 56a, 56b is to encode the laser signals 60a, 64 in some way with the information contained in the signals 44, 46, thereby using the laser signals 60a, 64 as carriers of the information.

The signals 66, 67 may then be added together in a combiner 69 to form a multiplexed output 72 for transmitting across a carrier medium, such as an optical fiber 72. The use of quadrature amplitude modulation, using an in-phase and quadrature component as described above, may have the advantage of providing an output 72 with a constant envelope. As a result, a constant envelope may reduce distortion in the output 72 if the output 72 is amplified by a nonlinear amplifier, for example.

Referring to FIG. 2, while referring generally to FIG. 1, the orthogonal codes provided by the filters 28a-c, 30a-c (referring back to FIG. 1) may be illustrated by a matrix 88, such as the Walsh-code matrix 88. Each Walsh code may be represented by a row 90 of ones or negative ones, each orthogonal from the other. This means that when the elements of each individual code 90 are squared and added together the result is nonzero, but when the individual elements of each row 90 are multiplied with the corresponding elements of another row 90 (either above or below), the sum of the products is equal to zero.

For example, when the individual elements of a row 90a are multiplied with the individual elements of another row 90b and added together, the result is zero. The same rule holds true for any pair of rows 90 selected from the matrix 88. Additionally, the Walsh-code matrix 88 need not be limited to the rows 90 comprising four elements as illustrated, but each row may comprise 2ⁿ elements for any whole number n. The number n may be determined by engineering according to the number of codes needed to encode the data signals 12 (Referring back to FIG. 1) input to the multiplexer 10.

To represent the Walsh codes, square pulse Walsh functions may be replaced with windowed pulses such as half-sine, Gaussian, or some other smoothly shaped function such as Blackman, Hanning, or Hamming windows, as illustrated by the waveforms 80a-d. Walsh functions of selectable length (L 2ⁿ, where n=2, 3, 4 . . . ) may be used to produce a new higher rate bit stream (because each data bit may now be represented by a code having multiples “bits”) which is transmitted using MSK modulation. Walsh codes, which may be square waves, are represented using MSK modulation because of some advantageous properties of MSK modulation. MSK modulation may provide a constant envelope, which decreases distortion and self-interference when passed through nonlinear devices, such as amplifiers. Because of the properties of the coding, multiple MSK modulated signals may be added together and transmitted. These signals may be subsequently separated and recovered at the receiver by passing them through filters like those in the transmitter.

For example, referring back to FIG. 1, each pair of MSK Walsh filters, such as a pair 28a, 30a may encode the odd and even signals 22a, 24a with an MSK modulated Walsh code, such as is illustrated by waveform 80a. Likewise, other pairs 28b-d, 30b-c of filters may be configured to encode the signals 22b-c, 24b-c with other waveforms 80b-d, orthogonal to the first waveform 80a. As previously stated, the waveform 80a-d may represent a positive data bit, whereas a negative data bit may be represented by the waveform 80a-d inverted across the horizontal axis, as illustrated by the waveforms 82a-d. Finally, in the demultiplexer 100 or receiver 100, the original baseband data signals 12a-c may be extracted, as illustrated by the waveforms 84a-d.

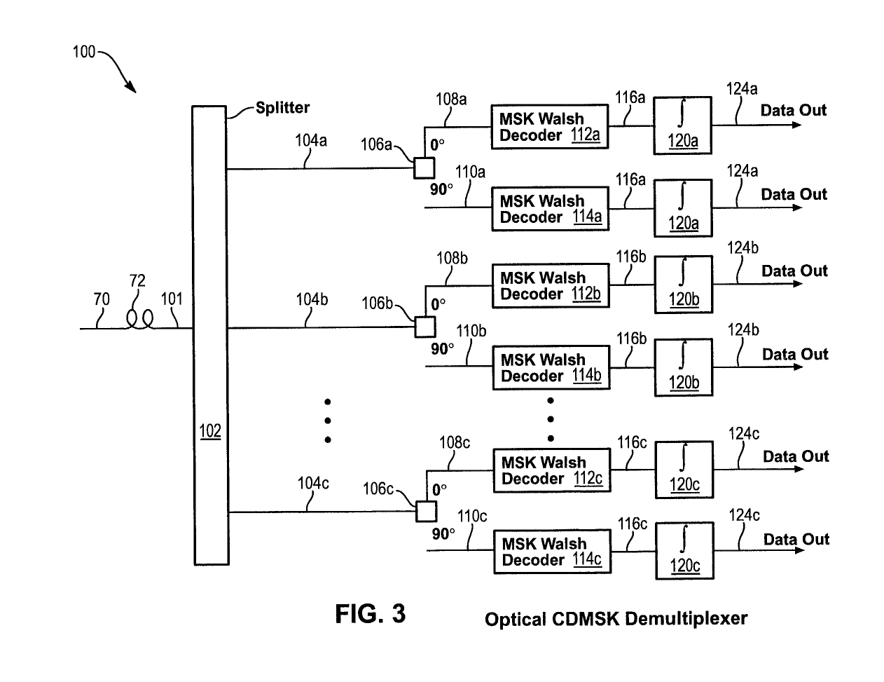

Referring FIG. 3, the demultiplexer 102 in accordance with the present invention may include a splitter configured to receive the multiplexed signal 101 from a carrier medium, such as an optical fiber 72. The splitter 102 may subsequently split the multiplexed signal 101 into identical daughter signals 104a-c. A second set of splitters 106a-c may be configured to split the signals 104a-c into granddaughter signals 108a-c, 110a-c, the signals 110a-c being phase shifted by 90°. MSK Walsh decoders 112a-c may be configured to extract the even signals from the signals 108a-c, while decoders 114a-c may be configured to extract the odd signals from the signals 110a-c. The word “decoder” is used herein to describe a device or method that provides an output for a selected waveform, such as is produced by the filters 28a, 30a in the multiplexer 10 in accordance with the present invention, but does not provide an output for other orthogonal waveforms.

Each decoder 112, 114 may actually receive all of the MSK encoded signals from all the channels, but will only have an output for the corresponding MSK waveform encoded in the transmitter. All other MSK waveforms may each provide a zero to the decoder 112, 114, since they are orthogonal to the desired MSK waveform. One embodiment in accordance with the present invention may also comprise integrating mechanisms 120a-c, 122a-c which may be configured to integrate over a time corresponding to the length of one MSK waveform, and output the corresponding even and odd baseband data signals 124a-c, 126a-c for each channel of the transmitter. In certain embodiments, the signals 124, 126 may be combined to reproduce the original baseband signals 12a-c of FIG. 1, or they may be kept separate to provide two distinct signals at half the data rate.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. An apparatus for photonic channel multiplexing using code-division minimum shift keying techniques, the apparatus comprising:
a carrier medium configured to carry first and second base band data channels configured to carry respective first and second baseband signals at a base data rate;
first and second derivation mechanisms configured to convert the first and second baseband signals into first and second series of impulses, respectively;
a first commutator configured to receive the first series and divide it into a first odd channel and a first even channel, each having half the base data rate;
a second commutator configured to receive the second series divide it into a second odd channel and a second even channel, each having half the base data rate;
first and second filters configured to encode the first odd channel and the first even channel, respectively, with a first orthogonal code; and
third and fourth filters configured to encode the impulses of the second odd channel and the second even channel, respectively, with a second orthogonal code.

2. The apparatus of claim 1, further comprising:
a first combiner configured to combine the first and second even channels into a first consolidated signal; and
a second combiner configured to combine the first and second odd channels into a second consolidated signal.

3. The apparatus of claim 2, further comprising:
a laser for providing a coherent photonic source signal;
a first amplitude modulator configured to modulate the laser with the first consolidated signal, thereby providing an in-phase signal; and
a second amplitude modulator configured to modulate the laser, phase-shifted by 90′, with the second consolidated signal, to provide a quadrature signal.

4. The apparatus of claim 3, further comprising a third combiner configured to combine the in-phase and quadrature signals into a multiplexed output.

5. The apparatus of claim 4, further comprising an output line configured to receive the multiplexed output.

6. The apparatus of claim 4, further comprising a splitter configured to split the multiplexed output into first and second daughter signals.

7. The apparatus of claim 6, further comprising:
a first decoder configured to receive the first daughter signal and extract the first even signal therefrom;
a second decoder configured to receive the first daughter signal and extract the first odd signal therefrom;
a third decoder configured to receive the second daughter signal and extract the second even signal therefrom; and
a fourth decoder configured to receive the second daughter signal and extract the second odd signal therefrom.

8. The apparatus of claim 7, further comprising:
a fourth combiner configured to combine the first even signal and the first odd signal to reproduce the first baseband signal; and
a fifth combiner configured to combine the second even signal and the second odd signal to reproduce the second baseband signal.

9. The apparatus of claim 1, wherein the first and second orthogonal codes are Walsh codes.

10. The apparatus of claim 9, wherein the Walsh codes are minimum shift keying waveforms.

11. A method for photonic channel multiplexing using code-division minimum shift keying techniques, the method comprising:
providing first and second baseband signals having a baseband data rate;
deriving from the first and second baseband signals a first and second series of impulses, respectively;
commutating the first series of impulses into a first odd channel and a first even channel, each having half the baseband data rate;
commutating the second series of impulses into a second odd channel and a second even channel, each having half the baseband data rate; and
encoding the first odd channel and the first even channel with a first orthogonal code; and
encoding the second odd channel and the second even channel with a second orthogonal code.

12. The method of claim 11, further comprising:
combining the first and second even channels into a first consolidated signal; and
combining the first and second odd channels into a second consolidated signal.

13. The method of claim 12, further comprising:
providing a source of coherent photonic signals;
modulating the source with the first consolidated signal, to provide an in-phase signal; and
modulating the source, phase-shifted by 90°, with the second consolidated signal, to provide a quadrature signal.

14. The method of claim 13, further comprising combining the in-phase and quadrature signals into a multiplexed output.

15. The method of claim 14, further comprising transmitting the multiplexed output through an optical fiber.

16. The method of claim 14, further comprising splitting the multiplexed output into first and second daughter signals.

17. The method of claim 16, further comprising:
extracting the first even signal from the first daughter signal;
extracting the first odd signal from the first daughter signal;
extracting the second even signal from the second daughter signal; and
extracting the second odd signal from the second daughter signal.

18. The method of claim 17, further comprising:
combining the first even signal and the first odd signal to reproduce the first baseband signal; and
combining the second even signal and the second odd signal to reproduce the second baseband signal.

19. The method of claim 11, wherein the first and second orthogonal codes are Walsh codes;

20. The method of claim 19, wherein the Walsh codes are minimum shift keying waveforms;
